(19) United States
(12) Patent Application Publication
(10) Pub. No.: US 2013/0008554 A1
(43) Pub. Date: Jan. 10, 2013

(54) FABRIC FOR PERSONAL PROTECTION GARMENTS

(75) Inventors: Michael Fisher, Mansfield (GB); Alan Brown, Mansfield (GB)

(73) Assignee: Toray Textiles Europe Limited, Mansfield (GB)

(21) Appl. No.: 13/635,755

(22) PCT Filed: Mar. 17, 2011
(86) PCT No.: PCT/GB11/00380

§ 371 Date: Sep. 18, 2012

Related U.S. Application Data
(60) Provisional application No. 61/388,652, filed on Oct. 1, 2010.

(30) Foreign Application Priority Data
Mar. 19, 2010 (GB) 1004692.8

(51) Int. Cl. D03D 23/00; B32B 5/16; D03D 49/50; D03D 25/00

(52) U.S. Cl. 139/418; 428/221; 139/116.1

(57) ABSTRACT

A fabric may be used in high visibility personal protection clothing. The yarn is capable of being dyed to a high visibility color and a non-fusible yarn are combined in a single fabric so as to provide a fabric which not only has heat and flame resistance but can also be dyed to high visibility colors. In particular, the fabric includes a flame retardant dyeable yarn and a non-fusible fibre yarn, wherein the yarns form a double faced fabric. The fabric may be a double faced weave wherein the flame retardant yarn is a flame retardant polyester and the non-fusible yarn is an aramid yarn.

### FIELD OF THE INVENTION

The present invention relates to a fabric for use in high visibility personal protection clothing.

### BACKGROUND

There are many situations where workers need to be highly visible, to prevent potential accidents. High visibility is often achieved using high visibility personal protection garments. There are also situations where workers are exposed to fire or heat hazard, therefore requiring personal protection garments that are both highly visible and heat and/or flame resistant.

One example is refuelling of aircraft where workers refuelling the aircraft on the runway need high visibility work wear so that they can be easily seen by other runway users. They also need protection against heat and flames in the event of an accident involving extremely flammable aircraft fuel.

Aramid yarns are often used to manufacture heat and flame resistant personal protection garments, due to the high level of protection they provide. However, these materials can not be dyed with high visibility colours, and therefore cannot be used to manufacture high visibility personal protection garments.

A solution employed by some workers is to layer a high visibility garment on top of a heat and flame resistant garment. This of course brings with it disadvantages of not having a heat and flame resistant outer layer, and the increased weight of wearing two layers of clothing instead of just one.

An alternative solution is to use a viscose and/or acrylic fabric which is chemically treated to provide flame resistance. Viscose and acrylic are both dyeable materials and can be dyed to high visibility colours. The main disadvantage of this type of fabric is that the chemical treatment will be removed over time, for example when the garment is cleaned, therefore decreasing the level of protection it provides. The added danger of this is that the wearer does not know what level of protection the garment is providing and when it needs replacing; with the risk that they may not have sufficient protection against the hazards they are exposed to.

An alternative solution (as set out in U.S. Pat. No. 7,312,166) is to provide a fabric with smothering yarn in combination with a conventional pigmented filament yarn (face) such that the combustion and flame spread of the pre-coloured yarn is moderated by the smothering gas produced by the smothering yarn. However, the modacrylic smothering yarn releases toxic gases such as HCl (hydrogen chloride) and pre-coloured yarns have been found to have a harsher handle. The present inventors have found that such structures have inferior drape and handle because of the requirement for both the additional smothering yarn component and the pre-coloured yarn component. A complex weave structure is also required in order to combine the three different types of yarn.

### SUMMARY OF THE INVENTION

At its most general, the present invention proposes that a yarn capable of being dyed to a high visibility colour and a non-fusible fibre yarn (i.e. a heat and flame resistant yarn) are combined in a single fabric so as to provide a fabric which not only has heat and flame resistance but can also be dyed to high visibility colours. In particular, the present invention proposes that the dyeable yarn is flame retardant (FR) yarn. In particular the flame retardant dyeable yarn is suitably of the “melt and surface shield” type, which provides flame retardancy by a completely different mechanism to a smothering gas yarn. Indeed, by using FR dyeable yarn there is no need for a smothering gas yarn. Thus, embodiments of the present invention do not contain smothering gas yarn.

A further advantage of using FR dyeable yarn is that embodiments have a “soft handle”. For example, softness can be achieved during the fabric dyeing process, typically Jet Dyeing (e.g. liquor flow Jet Dyeing).

By combining the two different yarns in a single piece fabric in this way, the weight of the fabric can be kept low whilst resisting heat and flame, thereby addressing the drawbacks discussed above.

In a first aspect, the present invention provides a fabric comprising a dyeable yarn and a non-fusible fibre yarn, wherein the yarns form a double faced fabric.

Suitably the fabric is a woven fabric and the yarns form a double faced weave. Thus, suitably the yarns are woven together in a single process to form the double faced fabric.

Thus, the dyeable yarn and non-fusible fibre yarn interlink (e.g. interweave) to form a single layer fabric. An advantage of this arrangement is that there is no need for chemical treatment to impart heat and flame resistance because the non-fusible yarn is integral to the fabric.

Furthermore, the use of a double faced fabric (e.g. double faced weave) is advantageous because it permits the component yarns to be directed to a position in the fabric where they can best achieve their intended function. For example, it allows a desired amount of the dyeable yarn to be exposed on the fabric face. Indeed, by appropriate selection of the weaving pattern it is possible to adjust the colour depth that can be achieved on the fabric face. Similarly, the non-fusible yarn can be selectively positioned on the fabric back to optimise heat and flame resistance.

The following discussion of optional and preferred features refers to double faced weaves, being the particularly preferred type of double faced fabric. Nevertheless, the features apply equally, mutatis mutandis, to a double faced fabric.

Preferably, the major component of the weave face (front face of the weave, being the side that, in use as a garment, would be visible) is the dyeable yarn. Suitably at least 60%, preferably at least 65% and most preferably at least 70% of the weave face is the dyeable yarn. Suitably, the major component of the weave back (back face of the fabric) is the non-fusible fibre yarn. It is particularly preferred that the major component of the weave face is dyeable yarn and the major component of the weave back is non-fusible fibre yarn. This is particularly advantageous because it means that the weave face can be dyed to a high visibility colour, preferably of sufficient depth of shade to meet the EN471 standard. The greater the percentage of dyeable yarn on the weave face, the greater the intensity of high visibility colour that can be achieved and hence a worker will be more visible when the fabric is used in a personal protection garment.

Non-fusible fibre yarn, for example aramid yarn, generally cannot be dyed to high visibility colours and it is therefore advantageous to locate the non-fusible yarn on the weave back. In this way, the “dilution” of the dyeable yarn of the weave face can be minimised. Also, the heat and flame resistance of the fabric is maintained without detriment to the colour intensity/depth of shade of the weave face.

Whilst any suitable non-fusible yarn can be used, it is preferred that the non-fusible fibre yarn is an inherently heat and flame/fire resistant yarn, preferably an aramid yarn. Suitably, the aramid yarn is a ring spun yarn. Suitably the aramid yarn is a short staple yarn. Preferably the aramid yarn is a spun staple yarn.

Preferably, the aramid yarn comprises meta aramid. Preferably the aramid yarn is a meta aramid yarn. Typically the aramid yarn comprises at least 50% (wt % based on the weight of the yarn) meta aramid, more typically at least 80% meta aramid and most typically at least 90% meta aramid. A particularly preferred range is 85% to 95% meta aramid, with about 93% especially preferred.

Preferably the aramid yarn comprises para aramid. Preferably the para aramid content is at least 2% (wt % based on the weight of the yarn), more preferably at least 4%. Suitably the para aramid content is no more than 20%, preferably no more than 10%, more preferably no more than 8%. A particularly preferred range is 4% to 8%, with about 5% especially preferred. Preferably the aramid yarn is a meta aramid and para aramid blend.

Suitably, the aramid yarn contains anti stat, preferably in an amount of 1% to 5% (wt % based on the weight of the yarn), more preferably 1% to 4% and especially about 2%. An example of a suitable anti stat material is P140 carbon fibre.

Indeed in a preferred embodiment, the aramid yarn is a blend, preferably a meta aramid, para aramid and anti stat blend. Preferably the blend comprises, suitably consists of, 85% to 95%, meta aramid, 4% to 8% para aramid and 2% to 4% anti stat. Especially preferred is for the aramid yarn to comprise about 93% meta aramid, about 5% para aramid and about 2% anti stat. The use of an Aramid yarn is particularly advantageous because aramid yarns do not have a melting point and do not support combustion and are therefore inherently heat and flame resistant. That is, they do not require chemical treatment to provide flame and heat resistant properties. Chemical treatment is not desirable because it diminishes over time and particularly after washing. This means that such fabrics need replacing regularly. It also means that the wearer of the garment is unsure of whether the fabric is providing the required protection (except in the unfortunate event of an accident) because there is no physical indication of when the garment needs replacing.

As noted above, preferably the dyeable yarn is flame retardant dyeable yarn. Thus, suitably the double faced fabric comprises a flame retardant dyeable yarn and a non-fusible yarn.

Preferably, the dyeable yarn is polyester yarn, suitably flame retardant polyester (FR polyester) yarn. It is particularly preferred that the polyester yarn is polyethylene terephthalate yarn. Polyester is readily dyed to a high visibility colour.

The dyeable yarn can comprise a mixture of materials (e.g. a mixture of fibres), i.e. a blend. For example, the dyeable yarn can be polyester blended with viscose and/or modacrylic. Typically the major component is polyester to ensure that the yarn as a whole can be dyed to the desired high visibility colour as explained herein.

It has been found that multifilament yarn provides high durability as compared to staple yarns which are prone to pilling. Suitably, the dyeable yarn is a multi-filament yarn, preferably a multi-filament polyester yarn. Suitably the multi-filament yarn is textured yarn.

Preferably the dyeable yarn has a high visibility colour (i.e. it has been dyed, e.g. piece-dyed as described herein).

Suitably, the weave face of the double faced weave is a plain weave or a twill weave, with twill weave being preferred. Preferably, the weave rear of the double faced weave is a plain weave. It is particularly preferred to have a double faced weave wherein the weave face is a twill weave and the weave rear is a plain weave. An advantage of providing a twill weave for the weave face is that better colour intensity/depth of shade can be achieved, in particular where the twill pattern is provided by the dyeable yarn as weft yarn because a greater proportion of the weave face can then be provided by the dyeable yarn. In other embodiments, the weave face and the weave rear are plain weave.

In other embodiments the weave face is a plain weave and the weave rear is a twill weave. Thus, the double faced weave has a plain weave face and a twill weave rear. This has also been found to provide excellent colour intensity and depth of shade.

As discussed herein, dyeable yarn (e.g. polyester yarn) warp ends can be introduced to the weave face to increase the colour intensity of the weave face. Indeed, in embodiments the weave face is about 100% dyeable yarn (e.g. polyester yarn).

In addition to plain and twill weaves, the weave can also be selected from repp or ripstop. It is particularly preferred that the weave face is selected from twill, plain, repp and ripstop weave and the weave back is selected from plain and twill weave.

Preferably the non-fusible yarn is aramid yarn and is selected from about 40/2 Nm to 100/2 Nm aramid yarn, more preferably about 55/2 Nm to 85/2 Nm, more preferably 60/2 Nm to 85/2 Nm, more preferably 70/2 Nm to 80/2 Nm and most preferably about 75/2 Nm.

In other embodiments, the non-fusible yarn is aramid yarn and is selected from about 40/2 Nm to 100/2 Nm aramid yarn, more preferably about 55/2 Nm to 85/2 Nm, more preferably 50/2 Nm to 75/2 Nm, more preferably 55/2 Nm to 60/2 Nm and most preferably about 60/2 Nm.

Preferably the double faced weave is woven from 1 or 2 warp yarns, typically 2 warp yarns. In embodiments where there is only 1 warp yarn, suitably the yarn is a non-fusible fibre yarn (e.g. aramid yarn). In embodiments where there are 2 warp yarns, suitably one of the yarns is a non-fusible fibre yarn (e.g. aramid yarn) and the other yarn is a dyeable yarn (e.g. flame retardant yarn, typically FR polyester). In particularly preferred embodiments the double face weave is woven from a single warp yarn, being aramid yarn. In other embodiments, the double face weave is woven from two warp yarns, being aramid and a dyeable yarn (e.g. flame retardant yarn, typically FR polyester).

Preferably the double faced weave is woven from 2 weft yarns, suitably a non-fusible fibre yarn (e.g. aramid yarn) and a dyeable yarn (e.g. flame retardant yarn, typically FR polyester).

Preferably the weft comprises more dyeable yarn than non-fusible yarn. That is, preferably the major weft component is dyeable yarn. Suitably in the weft the dyeable yarn and the non-fusible fibre yarn are used in a ratio (dyeable yarn picks:non-fusible fibre picks) in the range 2:1 to 5:1, preferably 2.5:1 to 4:1, more preferably 2.5:1 to 3.5:1, more preferably 2.8:1 to 3.2:1 and most preferably about 3:1.

In other embodiments the ratio (dyeable yarn picks:non-fusible fibre picks) is in the range 1.1:1 to 5:1, preferably 1.1:1 to 4:1, more preferably 1.1:1 to 3.1:1, more preferably 1.1:1 to 2.1:1 and most preferably about 1.1:1.

Suitably, the minimum weft density is 35 threads/cm, preferably 45 threads/cm, and most preferably 43 threads/cm. A suitable maximum weft density is 60 threads/cm, preferably 55 threads/cm, more preferably 50 threads/cm and most preferably 48 threads/cm. In a preferred embodiment, the density of the weft is 35-60 threads/cm, more preferably 35-50 threads/cm, more preferably 40-50 threads/cm, and most preferably 43-48 threads/cm. A particularly preferred weft density is about 45 threads/cm.

In other embodiments, a suitable maximum weft density is 65 threads/cm, preferably 60 threads/cm, more preferably 55 threads/cm, more preferably 52 threads/cm and most preferably 50 threads/cm. In another preferred embodiment, the density of the weft is 35-65 threads/cm, more preferably 35-60 threads/cm, more preferably 40-55 threads/cm, more preferably 45-52 threads/cm and most preferably 45-50 threads/cm. A particularly preferred weft density is about 49 threads/cm or about 50 threads/cm.

Suitably, the minimum warp density is 40 threads/cm, preferably 43 threads/cm and more preferably 44 threads/cm. A suitable maximum warp density is 60 threads/cm, preferably 55 threads/cm, more preferably 50 threads/cm, and most preferably 48 threads/cm. In a preferred embodiment, the density of the warp is 40-60 threads/cm, more preferably 40-50 threads/cm and most preferably 44-48 threads/cm. A particularly preferred warp density is about 46 threads/cm.

In other embodiments, the minimum warp density is 40 threads/cm, preferably 45 threads/cm and more preferably 50 threads/cm. A suitable maximum warp density is 65 threads/cm, preferably 60 threads/cm, more preferably 58 threads/cm, more preferably 55 threads/cm, and most preferably 50 threads/cm. In another preferred embodiment, the density of the warp is 40-65 threads/cm, more preferably 40-60 threads/cm, more preferably 44-58 threads/cm, more preferably 44-55 threads/cm and most preferably 48-52 threads/cm. A particularly preferred warp density is about 50 threads/cm.

Embodiments employing these warp and weft densities provide particularly good resistance to flame spread. Furthermore, the combination of these warp and weft densities with the double-faced weave structure provide particularly good mechanical properties, for example tensile and tear strength.

Preferably, the maximum fabric/weave weight is 400 g/m², more preferably 380 g/m², more preferably 350 g/m², and most preferably 340 g/m². A suitable minimum weave weight is 200 g/m², preferably 250 g/m², more preferably 280 g/m², more preferably 300 g/m², and most preferably 320 g/m². In a preferred embodiment, the weave weight is 200-400 g/m², more preferably 300-400 g/m², more preferably 300-350 g/m² and most preferably 320-340 g/m². A particularly preferred weave weight is about 330 g/m². Suitably these fabric/weave weights refer to the fabric after shrinking.

In other embodiments, the maximum fabric/weave weight is 400 g/m², more preferably 350 g/m², more preferably 300 g/m², and most preferably 280 g/m². A suitable minimum weave weight is 200 g/m², preferably 220 g/m², more preferably 240 g/m², more preferably 260 g/m², and most preferably 270 g/m². In a preferred embodiment, the weave weight is 200-400 g/m², more preferably 225-350 g/m², more preferably 250-300 g/m² and most preferably 260-280 g/m². A particularly preferred weave weight is about 270 g/m². Suitably these fabric/weave weights refer to the fabric after shrinking.

These weave weights ensure that garments formed from the fabric are light weight and therefore comfortable to wear. Nevertheless, they are sufficiently substantial to provide a robust and durable fabric.

The weight and construction of the weave also provides the additional advantage of a drapable fabric, which is easier to use in downstream manufacture of items such as personal protection garments.

In particular, the present inventors have observed that the provision of a flame retardant dyeable yarn permits a simple fabric structure whereby additional components are not required. Specifically, the desired high visibility colour is provided by dyeing (suitably piece dyeing) the FR dyeable yarn, and the substantive heat and flame resistance is provided by the non-fusible (suitably aramid) yarn. As the “high visibility” yarn (the FR dyeable yarn) is inherently flame retardant there is no need to provide a further yarn (e.g. a smothering yarn) or to provide treatment (e.g. chemical padding) to the fabric. Indeed, in preferred embodiments, there are only two types of yarn present in the double faced fabric: FR dyeable yarn and non-fusible yarn, preferably FR polyester yarn and aramid yarn. The combination of FR dyeable yarn and non-fusible (e.g. aramid) yarn therefore represents a valuable contribution to the art whereby high visibility and heat/flame resistance is provided by a simple and hence lightweight double faced fabric, which is simpler to manufacture and represents efficient use of the component yarns.

An embodiment of the present invention is a double faced weave; wherein a flame retardant polyester yarn is the major component of the weave face and an aramid yarn is the major component of the weave back, suitably with a fabric weight 200-400 g/m². This weave structure has significant advantages because it combines the benefits of the excellent heat resistant and flame resistant properties of the aramid with the dyeable properties of the flame retardant polyester in a single lightweight drapable fabric, thereby providing a product that has excellent flame and heat resistance and can be dyed to high visibility colour.

Suitably at least 40% (wt % based on the weight of the woven fabric) of the yarn in the woven fabric is dyeable yarn, for example flame retardant dyeable yarn, for example polyester yarn, more preferably at least 43% and most preferably at least 45%. A particularly preferred value is about 46%.

Suitably at least 40% (wt % based on the weight of the woven fabric) of the yarn in the woven fabric is non-fusible fibre yarn (e.g. aramid yarn, for example an aramid blend yarn), more preferably at least 45%, more preferably at least 50%. A particularly preferred value is about 54%.

Suitably the dyeable yarn and non-fusible fibre yarn are the only yarns in the woven fabric. Preferably the woven fabric consists essentially of, more preferably consists of, the dyeable yarn and the non-fusible fibre yarn. Suitably the fabric does not include a smothering yarn (smothering yarn evolves a smothering gas when exposed to a flame, said gas inhibiting the combustion of one or more other yarns in the fabric).

In embodiments, for example where the fabric is part of a garment, the double faced weave may be provided in combination with one or more other materials or textiles.

For example, a garment may comprise a plurality of layers, of which one is the double faced weave.

Suitably the double faced fabric achieves one or both of the following standards: ISO EN61482-1-1 ASTM F1959 Thermal Protection to Open Arc; and ISO 11612 Heat and Flame. Preferably the fabric additionally passes the EN471 standard as discussed below.

Suitably the double faced fabric is dyed. That is, suitably at least some, preferably substantially all, of the dyeable yarn is dyed so that the dyeable yarn is coloured. This can be achieved for example by piece dyeing as described herein. Suitable colours are high visibility colours (e.g. fluorescent colours), but standard colours are also possible. Thus, suitably the double faced weave fabric comprises high visibility dyeable yarns.

In other embodiments, the double faced fabric is not dyed. Indeed, an advantage of the present invention is that the fabric can be processed and finished like any other fabric. For example, the fabric can be piece dyed or prepared for printing and coating. This provides valuable flexibility to the manufacture of the fabric, for example permitting quick response and reduced waste.

Suitably the double faced weave fabric passes the EN471 standard. Suitably the double faced weave fabric passes the flame spread (clause 6.3.2), convective heat (clause 7.2) and radiant heat (clause 7.3) requirements of the EN IS011612.2008 standard.

Preferably the high visibility colour of the fabric face is such that the x, y chromacity co-ordinates of the coloured yarn face satisfy any one of the following (corresponding to EN471):
Fluorescent Yellow: (0.387, 0.610), (0.356, 0.494), (0.398, 0.452), (0.460, 0.540);
Fluorescent Orange:(0.610, 0.390), (0.535, 0.375), (0.570, 0.340), (0.655, 0.345); and
Fluorescent Red: (0.655, 0.345), (0.570, 0.340), (0.595, 0.315), (0.690, 0.310).

Suitably the minimum luminance factor Bₘᵢₙ is about 0.70 (yellow), 0.40 (orange), 0.25 (red).

In a further aspect, the present invention provides a fabric (suitably a woven fabric) comprising a dyeable yarn and a non-fusible fibre yarn wherein the yarns form a double faced fabric (preferably a double faced weave), and wherein the fabric passes the EN 471 standard. The optional and preferred features of the first aspect suitably also apply to this aspect. In particular, suitably the dyeable yarn is FR dyeable yarn and preferably the dyeable yarn has been dyed (typically piece dyed as described herein).

In a further aspect, the present invention provides a woven fabric comprising a dyeable yarn and a non-fusible fibre yarn, wherein the yarns form a double faced weave and wherein the woven fabric passes the flame spread (clause 6.3.2), convective heat (clause 7.2) and radiant heat (clause 7.3) requirements of the EN IS011612.2008 standard. The optional and preferred features of the first aspect suitably also apply to this aspect. In particular, suitably the dyeable yarn is FR dyeable yarn and preferably the dyeable yarn has been dyed (typically piece dyed as described herein).

In a further aspect, the present invention provides a personal protection garment comprising a fabric, which fabric comprises a non-fusible fibre yarn and a dyeable yarn wherein the yarns form a double faced fabric (preferably a double faced weave). Suitably, the personal protection garment comprises the fabric of the first aspect. The optional and preferred features of the first aspect suitably also apply to this aspect. In particular, suitably the dyeable yarn is FR dyeable yarn and preferably the dyeable yarn has been dyed (typically piece dyed as described herein). Personal protection garments include, but are not limited to, trousers, jackets, t-shirts, shoe covers, gloves, hats, vests, arm bands and coveralls.

In a further aspect the present invention provides a protection cover comprising a fabric comprising a non-fusible fibre yarn and a dyeable yarn, wherein the yarns form a double faced fabric (preferably a double faced weave). Suitably, the protection cover comprises the fabric of the first aspect. The optional and preferred features of the first aspect suitably also apply to this aspect. In particular, suitably the dyeable yarn is FR dyeable yarn and preferably the dyeable yarn has been dyed (typically piece dyed as described herein). Protection covers include, but are not limited to, covers for bags, covers for rucksacks and covers for work boxes.

In a further aspect, the present invention provides a method of manufacturing a fabric comprising a dyeable yarn and a non-fusible fibre yarn, the method comprising the step of processing the dyeable yarn and the non-fusible fibre yarn to form a double faced fabric.

Preferably the fabric is a woven fabric, and the step of processing the dyeable yarn and a non-fusible fibre yarn comprises weaving the dyeable yarn and a non-fusible fibre yarn to form a double faced weave.

The optional and preferred features of the first aspect suitably also apply to this aspect. In particular, suitably the dyeable yarn is FR dyeable yarn and preferably the method includes dyeing the dyeable yarn (typically piece dyeing as described herein).

In one embodiment, the weave is woven using a twill weave on the weave face and a plain weave on the weave back and wherein the weave is woven using 1 warp yarn, being the non-fusible fibre yarn, and 2 weft yarns, being the non-fusible fibre yarn and the dyeable yarn.

In another embodiment, the weave is woven using a plain weave on the weave face and a twill weave on the weave back and wherein the weave is woven using 2 warp yarns, being the non-fusible fibre yarn and dyeable yarn, and 2 weft yarns, being the non-fusible fibre yarn and the dyeable yarn.

Suitably, the woven fabric, preferably the warp yarn, is shrunk after weaving. It is advantageous to shrink the warp yarn as part of the finishing process because this causes the dyeable weft yarn to cover the non-fusible fibre weft yarn, effectively moving it to the reverse, thus producing a greater coverage of dyeable yarn on the face of the fabric, which increases the colour intensity of the weave face when dyed. Indeed, it is an advantage of the present invention that the double faced fabric can be finished, including shrinking, in the same way as other single layer fabrics, for example polyester fabrics.

Suitably the extent of shrinkage of the warp and/or weft (preferably both) is in the range 5% to 15%, preferably 6% to 14%, more preferably 7% to 13% and most preferably 8% to 12%. In embodiments, this enables change in the density of the fabric and/or increased fabric cover.

Suitably the fabric weight increases, for example by at least 5%, preferably at least 10%, more preferably at least 12% and most preferably at least 14%. Generally shrinkage does not increase the fabric weight by more than about 20%.

Suitably the fabric weight increases, for example from about 230-240 g/m² to about 260-280 g/m². In a particularly preferred embodiment, the fabric weight increases from about 236 g/m² to about 270 g/m² after shrinkage.

Suitably shrinkage causes the warp ends to increase, for example from about 42-47/cm to about 48-52/cm. In particularly preferred embodiments, the warp ends increase from about 45/cm to about 50/cm.

Suitably, weft picks increase, for example from about 42-47/cm to about 48-52/cm. In particularly preferred embodiments, the weft ends increase from about 45/cm to about 50/cm

Preferably both the warp ends and the weft ends increase as a result of the shrinkage step.

Preferably, the fabric is piece dyed, suitably to a high visibility colour. It is advantageous to piece dye the fabric because piece dying makes the downstream manufacture of items such as corporate identity personal protection garments, easier and cheaper. Indeed, since, the fabric can be produced without an added colour (dye) and cut to size and piece dyed to the required colours, this ultimately reduces waste, and therefore cost. Embodiments of the double faced fabric have been dyed, preferably piece dyed, preferably to a high visibility colour.

In a further aspect, the present invention provides a fabric made in a method as described herein, for example a method according to the aspect above.

In a further aspect, the present invention provides a personal protection garment or a protection cover made in a method as described herein.

In a further aspect, the present invention provides the use of a dyeable yarn and a non-fusible yarn to form a double faced fabric (preferably a double faced weave).

Preferably, the dyeable yarn and non-fusible yarn are used to form a personal protection garment.

Any one or more of the aspects of the present invention may be combined with any one or more of the other aspects of the present invention. Similarly, any one or more of the features and optional features of any of the aspects may be applied to any one of the other aspects. Thus, the discussion herein of optional and preferred features may apply to some or all of the aspects. In particular, optional and preferred features relating to the fabric, for example the nature of the yarn, including the material and form (e.g. multi-filament), as well as the structure of the fabric (e.g. double-faced weave, yarn density) apply to all of the other aspects. Furthermore, optional and preferred features associated with a method or use may also apply to a product, in particular a protection garment, and vice versa.

### BRIEF DESCRIPTION OF THE DRAWINGS

Embodiments of the invention are described below, by way of example only, with respect to the accompanying drawings, in which:

FIG. 1 is a schematic illustration of the cross section of a double faced weave.

### DETAILED DESCRIPTION OF EMBODIMENTS

In this application, “double faced fabric” means a fabric in which the yarns are processed (e.g. by weaving) to form a single layer fabric with two faces. Such a single layer fabric is fabricated (e.g. woven) in a single step or process. A particularly preferred type of double faced fabric is a double faced weave.

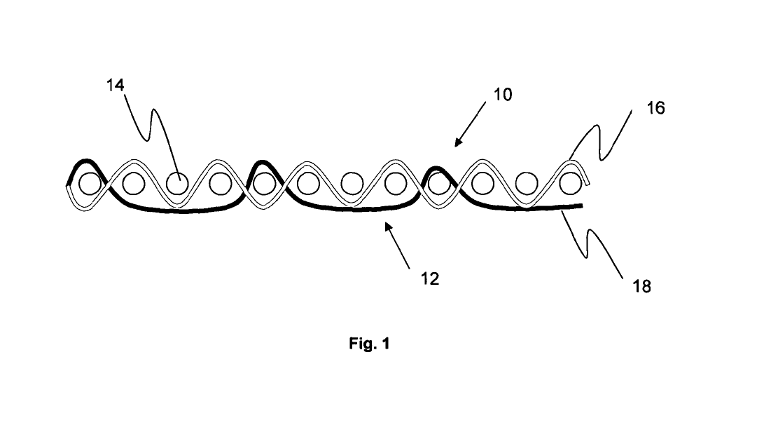

In this application, “double faced weave” means a type of double weave, where the yarns are woven to form a single layer fabric with two faces. A form of this weave has 1 warp and 2 weft yarns. FIG. 1 is a schematic cross section view of a basic example of a double faced weave. The double faced weave has two faces 10 and 12. The weft yarns 16 and 18 are woven between the warp yarn 14, which warp yarn 14 is common to both faces. By adjusting the weaving of the weft picks, a different pattern of weft yarns 16 and 18 and warp yarn 14 can be provided on each face.

Another form of this weave has 2 warp and 2 weft yarns. With reference to FIG. 1, warp yarns 14 comprise first and second warp yarns, for example aramid and dyeable yarn.

In this application, “fabric face” refers to the side of the fabric that, in use as a garment, would be visible and be exposed to heat etc. In the context of a double faced weave, the term “weave face” is used, and can be used interchangeably with “weave front” or “front face”.

In this application, “fabric back” refers to the side of the fabric that, in use as a garment would not be visible and closest to the user's skin. In the context of a double faced weave, the term “weave back” is used, and can be used interchangeably with “weave rear” or “rear face”.

In this application, “dyeable yarn” means a yarn which can be dyed to a high visibility colour. That is, a yarn that can be dyed with high visibility dyes. In particular, the dyeable yarn can be dyed so that a fabric formed only from the yarn (i.e. not a blend) will possess a high visibility colour that satisfies at least one of the EN471 colour coordinate requirements described herein. The skilled reader is aware of suitable dyeing processes and is readily able to distinguish between dyeable and non-dyeable yarns. Furthermore, the term “dyeable yarn” as used herein includes such yarns that have been dyed (e.g. piece dyed). That is, the term covers yarns both before and after dyeing. A suitable yarn is polyester, preferably flame retardant polyester.

In this application, “non-fusible fibre yarn” means a yarn manufactured from fibres which will not leave a molten trail on a hot surface at 300° C. These yarns therefore have good heat and flame resistance. An example of a non-fusible yarn is an aramid yarn. Aramid yarns do not support combustion and do not have a melting point.

As the skilled reader will recognise, the yarns disclosed herein are heat stable such that shrinkage and loss of mechanical properties is limited after exposure to high temperatures and/or flames for a short time (of around 3 to 4 seconds).

In this application, “flame retardant yarn” means the material from which the yarn is formed is inherently and permanently flame retardant, in contrast to yarns that have been treated (e.g. coated) to impart flame resistance. Typically this inherent flame retardancy arises because of the chemical make-up of the material. For example, in the case of a fibre yarn, the fibres are made from inherently flame retardant material. Flame retardant polyester (FR polyester) is a particularly preferred flame retardant yarn.

In a first example of the present invention, the fabric was woven using 1 warp yarn and 2 weft yarns. The warp yarn was a 75/2 Nm ring spun meta aramid, para aramid, anti stat blend yarn (Nomex® 93/5/2 with carbon P140 antistat). One of the weft yarns is a 2*167 dtex 64 filaments textured flame retardant polyester yarn, where the polyester is polyethylene terephthalate (Trevira® CS). The other weft yarn is the 75/2 Nm ring spun meta aramid, para aramid, anti stat yarn used for the warp yarn.

These yarns were then processed (woven) to produce a double-faced fabric. In this particular example, this was done using a twill weave on the weave face and a plain weave on the weave back but other patterns are possible. The twill weave was formed by patterning the weft yarns as 3 picks of flame retardant multi filament polyester yarn and 1 pick of spun staple aramid blended yarn. In particular, as viewed from the weave face, the flame retardant polyester weft yarn weaves over 5 warp ends and then under one warp end, before weaving back over the next 5 warp ends. Each fire retardant yarn weft pick is offset from the adjacent fire retardant polyester yarn weft pick by one warp end, thus creating a diagonal line of polyester weft picks. The weft picks were patterned 3 polyester picks to 1 aramid pick along the length of the warp ends. The aramid weft yarn weaves under 3 warp ends and over one warp end.

Once woven, the fabric underwent finishing processes that are standard in the art, such as scouring and drying. The fabric was also set. Again this is standard in the art. The setting process was adapted such that the warp of the weave was shrunk. This encouraged the weft to be compacted closer together comprising the “minor component” in the weft, the aramid yarn, to move to the reverse. This resulted in a weave face where the majority of the visible yarn is flame retardant polyester, and the majority of the visible yarn of the weave back is aramid.

After these processes the weave had a warp density of 46 threads/cm and weft density of 45 threads/cm. The weight of the fabric was 330 g/m²

The overall composition of the finished double faced weave (as a wt % based on weight of the woven fabric) was 46% polyethylene terephthalate, 50% meta aramid, 3% para aramid and 1% anti stat.

The fabric can then be piece dyed to high visibility colours. Only the weave face (i.e. the FR polyester) will take the colour of the dye. This means the whole fabric can be placed in a dye tank, in order to dye the fabric front to a high visibility colour.

An additional benefit of piece dyeing is soft handle which is advantageous to wearer comfort. The softness can be achieved during fabric dyeing, especially liquor flow jet dyeing. “Soft handle” can be measured by the Kawabata Evaluation System (KES) developed for lightweight apparel. In the present example, the KES bending property “flexible rigidity” was less than 0.5 gf cm²/cm in both warp and weft direction. Usually, KES can not be carried out on typical fabrics for protective apparel due to their stiffness. Thus embodiments of the present invention provide not only impressive levels of high visibility and flame resistance but also soft handle, which is a valuable combination of properties.

In this example the use of flame retardant multifilament polyester yarn provides several advantages. Firstly, it is dyeable, so the weave face can be dyed to high visibility colours. Secondly, the multifilament construction of the yarn means that it is resistant to pilling (high abrasion resistance) and is durable. Thirdly heat resistant properties contribute to the overall heat resistance of the fabric and provides good wash-dry shrinkage performance for easy care. Additionally, the FR polyester has low toxicity during burning.

The use of a spun staple aramid blend is also advantageous due to the extremely good inherent heat and flame resistant properties of this type of yarn.

The use of a double faced weave, with a twill face and plain back, provides additional advantages of preventing flame spread. The weave also provides excellent mechanical properties such as tensile and tear strength, and the construction produces a light weight fabric, which is particularly advantageous for fabrics that will be used in the construction of work wear. The double faced weave construction also ensures that the majority of the flame retardant multi filament polyester yarn is on the weave face. This is an efficient use of the yarns, such that the polyester yarn is directed to the weave face; the side requiring colour and resistance to pilling. The double faced weave also means that the polyester and aramid yarns are interwoven; this not only improves the mechanical properties, but means the weave as a whole has excellent flame and heat resistance.

The limitation of flame spread and mechanical properties of the fabric are further improved by the shrinkage of the weave warp, which increases the density of the weft. This warp shrinkage also increases the coverage of polyester yarn on the weave face, which increases the intensity of colour of the weave face when dyed.

Piece dying the fabric provides further additional benefits to down stream uses of the fabric. For example, when manufacturing corporate work wear, the fabric can be cut to size and then piece dyed to the required colour. This is more efficient, and reduces waste and therefore cost.

The fabric of the example was tested and found to have excellent flame resistance, mechanical properties and high visibility colour. In particular, the relevant parts of EN ISO 11612: 2008, and EN 471 were passed.

In a second example of the present invention, the fabric was woven using 2 warp yarns and 2 weft yarns. The first warp yarn was a 60/2 Nm ring spun meta aramid, para aramid, anti stat blend yarn (Nomex® 93/5/2 with carbon P140 antistat). The second warp yarn is Trevira® CS 1/167/64 filaments textured FR polyester. One of the weft yarns is a 1*167 dtex 64 filaments textured flame retardant polyester yarn, where the polyester is polyethylene terephthalate (Trevira® CS). The other weft yarn is the 60/2 Nm ring spun meta aramid, para aramid, anti stat yarn as used for the warp yarn.

These yarns were then processed (woven) to produce a double-faced fabric. In this particular example, this was done using a plain weave on the weave face and a twill weave on the weave back but other patterns are possible. The face was formed by patterning the weft yarns as 1 pick of flame retardant multifilament polyester yarn and 1 pick of spun staple aramid blended yarn. In particular, as viewed from the weave face, the flame retardant polyester weft yarn weaves over 1 warp end and then under one warp end. Each fire retardant yarn weft pick is offset from the adjacent fire retardant polyester yarn weft pick by one warp end. The weft picks were patterned 1 polyester pick to 1 aramid pick along the length of the warp ends. The aramid weft yarn weaves under 2 warp ends and over one warp end.

Once woven, the fabric underwent finishing processes in the same way as the previous example. This encouraged the weft to be compacted closer together causing the “minor component” in the weft, the aramid yarn, to move to the reverse. This resulted in a weave face where 100% of the visible yarn is flame retardant polyester, and the majority of the visible yarn of the weave back is flame resistant aramid.

After these processes the weave had a warp density of 50 threads/cm and weft density of 50 threads/cm. The weight of the fabric was 270 g/m²

The overall composition of the finished double faced weave (as a wt % based on weight of the woven fabric) was 42% polyethylene terephthalate, 54% meta aramid, 3% para aramid and 1% anti stat.

In the same way as the first example, the fabric can be piece dyed to high visibility colours. Similarly, the use of flame retardant multifilament polyester yarn and the spun staple aramid blend provides the same advantages as the first example.

In the present example, the KES bending property “flexible rigidity” was less than 0.5 gf cm²/cm in both warp and weft direction. As noted above in respect of the first example, the fabric of the second example provides not only impressive levels of high visibility and flame resistance but also soft handle, which is a valuable combination of properties.

Furthermore, the use of a double faced weave, with a plain face and twill back, provides an additional advantage of preventing flame spread and excellent mechanical properties such as tensile and tear strength. The weave construction produces a light weight fabric, which is very useful in the context of work wear.

In the same way as the first example, the double faced weave construction ensures that the majority of the flame retardant multi filament polyester yarn is on the weave face, which is an efficient use of the yarns. The interwoven structure that is inherent to the double faced weave not only improves the mechanical properties, but means the weave as a whole has excellent flame and heat resistance.

Tests have shown that the shrinkage of the weave warp (for example in the setting step), which increases the density of the weft, improves the limitation of flame spread and mechanical properties of the fabric. The shrinkage of the warp also increases the colour properties of the weave face when dyed due to the increase in polyester yarn coverage on the weave face.

As with the fabric of the first example, the fabric of the second example was tested and found to have excellent flame resistance, mechanical properties, high visibility colour and thermal resistance to electric arc. In particular, the following demanding tests were passed:

ISO 11612:2008 (Protective clothing—clothing to protect against heat and flame)

ISO 11611:2007 (Protective clothing for use in welding and allied processes)

ISO 14116: 2008 (Protective clothing—thermal performance)

BS EN 471:2003+A1; 2007 (High visibility warning clothing for professional use)

BS EN 471: 2003 incl (GO/RT 3279: 2008 for railway industry)

EN 1150:1999 (High visibility)

EN 1149-3:2004 (Charge decay)

EN 61482-1-2: 2007 (Arc Box Test)

ASTM F1959 equiv. (EN 61482-1-1) (Fabric Open Arc Test)

In particular, the fabrics of both examples passed the following EN ISO 11612: 2008:
Limited flame spread—Face ignition (A1) [ISO 15025:2000 Procedure A]—pass A1 (both before and after pre-treated fabrics)
Limited flame spread—Edge ignition (A2) [ISO 15025:2000 Procedure B]—pass A2 (both before and after pre-treated fabrics)
Convective heat (Code letter B) [ISO 9151:1995]—pass level B1
Radiant heat (Code letter C) [ISO 6942:2002 Method B at 20 kW/m²]—pass level C1

Indeed, the fabrics performed excellently in the flame spread test, with no after flame or after glow occurring.

The fabric also performed well in the tests for thermal resistance to electric arc:

Electric Arc test EN 61482-1-2: 2007 Box Test to Class 1, and

Fabric Open Arc test ASTM F1959/F1959M—O6ae 1 Live Working—flame resistant materials for clothing, thermal hazards of an electric arc, (equivalent to EN 61482-1-1 Open Arc), achieving an Arc Thermal Performance Value (ATPV)>8.0 Cal/cm².

Thus, embodiments of the present invention conform to a number of demanding tests. In particular, impressive performance has been achieved with respect to the combination of (a) ISO 11612 Heat and Flame, ISO 11611 Welding & Allied processes, ISO 14116 Thermal Performance; (b) Dyeability to EN471 (high visibility and GO/RT rail); and (c) ISO EN61482-1-1 ASTM F1959 Thermal Protection to Open Arc.

1.-17. (canceled)

18. A fabric comprising a flame retardant dyeable yarn and a non-fusible fibre yarn, wherein the yarns form a double faced fabric.

19. The fabric according to claim 18, wherein the fabric is a woven fabric and the yarns form a double faced weave.

20. The woven fabric according to claim 19, wherein the flame retardant dyeable yarn is a flame retardant polyester yarn.

21. The woven fabric according to claim 19, wherein the non-fusible fibre yarn is an aramid yarn.

22. The woven fabric according to claim 19, wherein a major component of a weave face is the flame retardant dyeable yarn.

23. The woven fabric according to claim 19, wherein a major component of a weave back is the non-fusible fibre yarn.

24. The woven fabric according to claim 19, wherein a weave face is a twill weave and a weave back is a plain weave.

25. The woven fabric according to claim 19, wherein a weave face is dyed to a high visibility color such that the weave face passes EN471.

26. The woven fabric according to claim 19, wherein density of weft yarns is 35-60 threads/cm.

27. The woven fabric according to claim 19, wherein density of warp yarns is 40-60 threads/cm.

28. The woven fabric according to claim 19, wherein the fabric has a weight of 200-400 gms/m².

29. The woven fabric according to claim 19, wherein the fabric passes flame spread (clause 6.3.2), convective heat (clause 7.2) and radiant heat (clause 7.3) requirements of an EN ISO 11612: 2008 standard and an EN471 standard.

30. A personal protection garment comprising the fabric of claim 19.

31. A method of manufacturing a fabric, wherein the method comprises the steps of processing a flame retardant dyeable yarn and a non-fusible fibre yarn to form a double faced fabric.

32. The method according to claim 31, wherein the fabric is a woven fabric, and the step of processing the flame retardant dyeable yarn and the non-fusible fibre yarn comprises weaving the flame retardant dyeable yarn and the non-fusible fibre yarn to form a double faced weave.

33. The method according to claim 32, wherein warp yarns are shrunk after weaving.

34. The method according to claim 31, wherein the fabric is piece dyed to dye the flame retardant dyeable yarn to a high visibility color to an EN471 standard.
